(19) United States
(12) Patent Application Publication
(10) Pub. No.: US 2004/0230016 A1
(43) Pub. Date: Nov. 18, 2004

(54) Alpha olefin-diene copolymers

(75) Inventors: John Richard Blackborow, Andresy (FR); Richard Henry Weatherhead, Addlestone (GB)

Correspondence Address: NIXON & VANDERHYE, PC, 1100 N GLEBE ROAD, 8TH FLOOR, ARLINGTON, VA, 22201-4714, US

(73) Assignee: BP Chemicals Limited, London (GB)

(21) Appl. No.: 10/875,168

(22) Filed: Jun. 25, 2004

Related U.S. Application Data
(63) Continuation of application No. 10/293,332, filed on Nov. 14, 2002.
Application No. 10/293,332 is a continuation of application No. 09/768,808, filed on Jan. 25, 2001, now abandoned.

(30) Foreign Application Priority Data
Jul. 25, 1998 (GB) 9816166.4
Dec. 3, 1998 (GB) 9826472.4

(51) Int. Cl. C08F 8/00; C08F 4/72

(52) U.S. Cl. 526/170; 525/326.1; 526/339; 526/335; 526/282

(57) ABSTRACT

Atactic copolymers derived from an alpha-olefin, optionally ethylene and a non-conjugated diene are provided. The units derived front the diene provide pendant groups having internal or terminal double bonds. Suitable dienes for preparing such copolymers include: CH₂═C(R¹)—R²—C(R³)═CH₂, CH₂═C(R¹)R⁴—C(R³)═CH—CH₃, wherein R¹ and R³ are indenpendently selected from hydrogen or an alkly group, R² and R⁴ are alkylene moieties having a chain length of at least 3 carbon atoms and at least 1 carbon atom respectively, or a diene having a cyclic ring with one strained ring double bond and a substituent on the ring of the Formulae: ═CR⁵R⁶, —CR⁷═CH₂, wherein R⁵ and R⁶ and R⁷ are independently selected from hydrogen or a C₁-C₃ alkyl. Also provided are processes for the functionalisation of the atactic copolymers and their use as lubricating oil additives.

The present invention relates to oil soluble atactic copolymers which contain pendant groups having double bonds. The present invention also relates to oil soluble additives prepared from the copolymers and useful as additives for lubricating oil compositions.

In the copolymerisation of alpha olefins and non-conjugated alkadienes which have two double bonds it is desirable that only one of the double bonds is incorporated into the polymer chain so that the resulting copolymer has a branched structure with pendant groups having double bonds. The double bond in the pendant group could be either terminal or internal depending on the structure of the non-conjugated diene. For example, alpha-omega dienes could result in pendant groups having terminal double bonds whereas alkadienes having a vinylidene group could result in pendant groups having internal double bonds. The presence of these pendant groups is desirable as their double bonds are highly reactive and enable the copolymer to be chemically modified to a copolymer having at least one pendant functional group, said functional group being capable of undergoing further chemical reaction with another material, or imparting desirable properties not otherwise possessed by the original oil soluble copolymer. Such modified copolymers may be suitable for use in lubricating oil compositions. It is therefore desirable that both the unmodified and chemically modified copolymers are oil soluble.

Copolymers of alpha olefins and non-conjugated dienes are known in the art. International patent application, WO 97/08216 discloses diene-modified propylene polymers which are prepared by reacting under suitable polymerisation conditions, propylene and one or more alpha-omega dienes and a metallocene catalyst system. Exemplified are copolymers prepared from 1,13 tetradecadiene, 1,9-decadiene, 1,7-octadiene and norbornadiene. The diene-modified propylene polymers so prepared are isotactic.

EP-A-0 811 642 discloses copolymers having a viscosity index (VI) of more than 160 derived from (A) 99.0-99.9 wt % of C₂ to C₂₀ alk-1-enes and (B) 0.01-1.0 wt % of C₅ to C₂₀ alpha-omega dienes. Exemplified are copolymers formed from dec-1-ene and 1,7-octadiene. Without wishing to be bound by any theory it is believed that under the reaction conditions employed in EP-A-0 811 642 the 1,7-octadiene has a marked tendency to insert into the polymer chain in a cyclic fashion i.e. the amount of pendant groups having a terminal double bond derived from the 1,7-octadiene would be low. This would account for the statement in EP-A-0 811 642 that the copolymers are distinguished by chemical inertness. The copolymers of EP-A-0 811 642 are also said to be suitable for use directly as viscosity improvers in lubricants and motor oils. This confirms that the copolymers of EP-A-0 811 642 have only low amounts of reactive pendant groups since the presence of reactive pendant groups having terminal double bonds would render the copolymers unsuitable for direct use as viscosity improvers.

International patent application, WO 98/49279 discloses a process for preparing amorphous polymers containing molecular units derived from propylene and molecular units derived from a polyene by contacting propylene and a polymerisable polyene in the presence of an amorphous polypropylene forming transition metal catalyst under polymerisation conditions. The polyenes used are non-conjugated polyenes having at least 7 carbon atoms and having two polymerisable double bonds. An exemplified polyene is 1,9 decadiene. WO 98/49229 discloses that such polyenes are not incorporated in the growing polymer in ring form but are preferentially reacted into different growing polymer backbones. This type of linkage is known as ‘H’-type branching. The resulting polymers contain predominantly ‘H’-type branching and a minimal number of intrachain rings. The existence of ‘H’-type branching can be detected by ¹³C NMR.

The problem is therefore to find oil soluble atactic copolymers which have pendant groups having reactive double bonds and to find a method of preparing such copolymers. The advantage of pendant groups having reactive double bonds is that they can be chemically modified to provide functionalised polymers suitable for use as lubricating oil additives.

Thus according to the present invention there is provided an atactic copolymer having units derived from (a) at least one alpha olefin (b) optionally ethylene and (c) at least one non-conjugated diene selected from the group consisting of

(i) a diene of the Formula:

CH₂═C(R¹)—R²—C(R³)═CH₂ (I)

wherein R¹ and R³ are independently selected from hydrogen or an alkyl group, and R² is an alkylene moiety having a chain length of at least 3 carbon atoms

(ii) a diene of the Formula:

CH₂═C(R¹)—R⁴—C(R³)═CH—CH₃ (II)

wherein R¹ and R³ are as defined as for Formula (I) and R⁴ is an alkylene moiety having a chain length of at least 1 carbon atom

(iii) a diene having a cyclic ring with one strained ring double bond and a substituent on the ring of the Formula:

═CR⁵R⁶ (III)

wherein R⁵ and R⁶ are independently selected from hydrogen or a C₁-C₃ alkyl group and

(iv) a diene having a cyclic ring with one strained ring double bond and a substituent on the ring of the Formula:

—CR⁷═CH₂ (IV)

wherein R⁷ is hydrogen or a C₁-C₃ alkyl group with the proviso that where the copolymer has units derived from a diene of Formula (I) or a diene having a cyclic ring with one strained ring double bond and a substituent on the ring of Formula (IV) at least 30 mol % of any units derived from the diene provide pendant groups having a double bond and less than 2 mol % of said units provide ‘H’-type branching.

The oil soluble copolymers of the present invention are atactic. By atactic is meant that the copolymer has substantially no isotactic or syndiotactic segments derived from the alpha-olefin which give rise to crystallinity, and where the copolymer has units derived from ethylene, the polymer has no significantly long segments (runs of ethylene) which give rise to crystallinity, as can be determined by the absence of a melting point and a heat of fusion of 0 J/g in DSC analysis (dynamic scanning calorimetry).

Where the copolymer has units derived from a diene of Formula (I) it is preferred that R¹ and R³ are independently selected from hydrogen, methyl and ethyl, more preferably R¹ and R³ are hydrogen. Preferably, R² is an alkylene moiety having a chain length of 3 to 22 carbon atoms i.e. the alkadiene preferably has a chain length of 7 to 26 carbon atoms. More preferably, R² is an alkylene moiety having a chain length of 5 to 8 carbon atoms i.e. the alkadiene has a chain length of 9 to 12 carbon atoms. Examples of suitable alkadienes of Formula (I) include 1,7-octadiene, 1,8-nonadiene, 1,9-decadiene, 1,10-undecadiene, and 1,11-dodecadiene, preferably 1,9-decadiene, 1,10-undecadiene, and 1,11-dodecadiene. Alkadienes of Formula (I) having a chain length of 9 to 12 carbon atoms are preferred because the alkadiene has less tendency to insert in a cyclic fashion to give cyclic units than alkadienes having a chain length of 7 or 9 carbon atoms. Thus, when the alkadiene is 1,9-decadiene, the resulting polymer has substantially no cyclic units.

Where the copolymer has units derived from a diene of Formula (II), R¹ and R³ are preferably as defined above for Formula (I). Preferably R⁴ is an alkylene moiety having a chain length of 1 to 21 carbon atoms i.e. the diene preferably has a chain length of 6 to 26 carbon atoms. More preferably, R⁴ is an alkylene moiety having a chain length of 1 to 7 carbon atoms i.e. the diene has a chain length of 6 to 12 carbon atoms. Examples of suitable dienes of Formula (II) include 1,4-hexadiene, 1,5-heptadiene, 1,6-octadiene, 1,7-nonadiene, 1,8-decadiene, 1,9-undecadiene, and 1,10-dodecadiene, preferably 1,8-decadiene, 1,9-undecadiene, and 1,10-dodecadiene.

Where the copolymer has units derived from a diene having a cyclic ring with one strained ring double bond and a substituent on the ring of Formula (III) it is preferred that R⁵ and R⁶ are independently selected from hydrogen, methyl and ethyl, more preferably R⁵ and R⁶ are hydrogen or methyl. Examples of suitable dienes include ethylidene norbornene, 5-(1-methylethylidene)-norbornene and methylene norbornene.

Where the copolymer has units derived from a diene having a cyclic ring with one strained ring double bond and a substituent on the ring of Formula (IV) it is preferred that R is selected from hydrogen, methyl and ethyl, more preferably R⁷ is hydrogen or methyl. Examples of suitable dienes include vinyl norbornene and 5-(1-methylethenyl)norbornene.

The non-conjugated dienes which may be used to form the copolymer of the present invention insert into the copolymer chain mainly in a 1,2 or 2,1 fashion. Where the copolymer has units derived from dienes of Formula (I) or dienes having a cyclic ring with one strained ring double bond and a substituent on the ring of Formula (IV) some small degree of cyclic insertion may also be obtained. Thus, the copolymer product depending on the particular diene employed may contain at least three different structural repeat units, that is, (a) units derived from the alpha olefin(s), (b) pendant groups having double bonds and (c) saturated cyclic structures. Units (b) and (c) are derived from the non-conjugated diene. Non-conjugated dienes of Formula (I) or dienes having a cyclic ring with one strained ring double bond and a substituent on the ring of Formula (IV) will provide pendant groups having terminal double bonds. Non-conjugated dienes of Formula (II) or dienes having a cyclic ring with one strained ring double bond and a substituent on the ring of Formula (III) will generally provide pendant groups having internal rather than terminal double bonds. Preferably at least 40 mol % of the units derived from the diene provide pendant groups having double bonds rather than cyclic structures, more preferably at least 50 mol %, most preferably at least 60 mol %, for example, at least 80 mol %. Suprisingly, when the copolymer has units derived from a non-conjugated diene of Formula (I) or dienes having a cyclic ring with one strained ring double bond and a substituent on the ring of Formula (IV) the copolymer contains substantially no ‘H’-type branching i.e preferably less than 2 mol % and, more preferably, less than 1 mol % of the units derived from the non-conjugated diene provide ‘H’-type branching. The use of the non-conjugated dienes of Formula (II) or diolefins having one strained ring double bond and a substituent on the ring of Formula (III) result in pendant groups having internal double bonds. This has the advantage that such pendant groups cannot further react to give saturated cyclic structures or ‘H’-type branching

Preferably, the pendant groups derived from the non-conjugated diene (hereinafter referred to as “pendant groups”) have at least four carbon atoms, preferably at least six and, more preferably, at least eight carbon atoms in the pendant chain. Non-conjugated dienes of Formula (I) suitably provide pendant groups of Formula (V):

—R²—C(R³)═CH₂ (V)

wherein R² and R³ are as defined above. Non-conjugated dienes of Formula (II) suitably provide pendant groups of Formula (VI):

—R⁴═C(R³)—CH₃ (VI)

wherein R⁴ and R³ are as defined above

Dienes having a cyclic ring with one strained ring double bond and a substituent on the ring of Formula (IV) suitably provide pendant groups having a terminal double bond.

Dienes having a cyclic ring with one strained ring double bond and a substituent on the ring of Formula (III) generally provide pendant groups with internal double bonds.

The copolymer chains of the present invention may have a vinylidene group, terminating one end of the chain (hereinafter referred to as a “vinylidene end group”). This is a result of the normal chain transfer mechanism as found in alpha olefin polymerisation. Preferably, the ratio of the olefinic moieties of the pendant groups to the vinylidene end group of the copolymer chain is in the range 0.1:1 to 4:1, more preferably 0.5:1 to 2:1, most preferably about 1:1.

Typically, the copolymers of the present invention contain on average more than one olefinic moiety per copolymer chain, preferably they contain 1.1 to 5, more preferably 1.5 to 3, of such moieties per copolymer chain. By olefinic moiety is meant an internal double bond, a terminal double bond or a vinylidene moiety.

The content of the units derived from the non-conjugated diene in the copolymer is preferably between 0.02 and 15 mol %, more preferably between 0.02 and 10 mol %, more preferably between 0.02 and 5 mol % and most preferably between 0.02 and 3 mol %. The content of the units derived from the non-conjugated diene in the copolymer can also be expressed in weight percent, in which case, the content of the units derived from the non-conjugated diene is preferably between 0.05 and 20 wt %, more preferably between 0.05 and 15, more preferably between 0.1 and 5 and most preferably between 1 and 5 wt %.

Suitably the alpha olefin is a C3 to C10 alpha olefin, such as propylene, 1-butene, 3-methyl-1-butene, 1-pentene, 3-methyl-1-pentene, 4-methyl-1-pentene, 4,4-dimethyl-1-pentene, 3-ethyl-1-pentene, 1-hexene, 1-heptene, 1-octene, 1-nonene, and 1-decene, preferably the alpha-olefin is a C3 to C5 alpha olefin and more preferably propylene or 1-butene.

For copolymers having units derived from alpha-olefins and no ethylene, the content of the units derived from the alpha-olefin(s) is preferably between 0.01 and 99.9 mol %. For copolymers having units derived from at least one alpha olefin and ethylene, the content of the units derived from the alpha olefin(s) is preferably between 40 and 99.9 mol %, and is more preferably greater than 60 mol %.

The copolymers of the present invention are oil soluble. This means they are fully miscible with, for example, lubricating oils such as SN150, SN500, hydrocracked oils and synthetic lubricating oils such as polyalphaolefins. Furthermore, the copolymers of the present invention are non-crystallisable from such oil solutions at temperatures above −40° C., preferably non-crystallisable from such oil solutions at temperatures above −30° C., more preferably they are non crystallisable from such oil solutions above −20° C.

The copolymers of the present invention are generally viscous liquids at ambient temperature i.e 25° C. Preferably, the copolymers have a viscosity in the range 50 cSt to 10 000 cSt, more preferably in the range 50 to 5000 cSt when measured at a temperature of 100° C.

The copolymers according to the invention preferably have a viscosity index (VI) in the range between 90 and 350, more preferably in the range 90 and 200, even more preferably their VI is less than 160, most preferably lying in the range between 100 and 159, where the viscosity index is determined in the same manner described in EP-A-0 811 642 i.e. according to ISO 2909 by measuring the viscosities at 40° C. and 100° C. of a 10 wt % solution of the polymers and subsequent conversion according to the tables contained in the ISO standard. The solvent used is a solvent neutral 100 oil manufactured by the British Petroleum Company and sold under the trade name Enerpar 20.

The copolymers of the present invention have a number average molecular weight (Mₙ) in the range 300 to 200 000, preferably in the range 400 to 20 000, more preferably in the range 450 to 10 000, even more preferably in the range 500 to 5000. The number average molecular weight of the copolymers prepared according to the present invention may be tailored according to the application required. For example, Mn is maintained in the range from about 300 to about 10,000 for dispersant applications and from about 15,000 to about 200,000 for combined dispersant and viscosity index improver applications.

The present invention also provides a process for the preparation of an atactic copolymer having units derived from (a) at least one alpha olefin (b) optionally ethylene and (c) at least one non-conjugated diene selected from the group consisting of:

(i) a diene of the Formula:

CH₂═C(R¹)—R⁴—C(R³)═CH—CH₃ (II)

wherein R¹ and R³ are independently selected from hydrogen or an alkyl group, and and R⁴ is an alkylene moiety having a chain length of at least 1 carbon atom and

(ii) a diene having a cyclic ring with one strained ring double bond and a substituent on the ring of the Formula:

═CR⁵R⁶ (III)

wherein R⁵ and R⁶ are independently selected from hydrogen or a C₁-C₃ alkyl group which process comprises contacting (a) at least one alpha olefin (b) optionally ethylene with (c) at least one non-conjugated diene selected from (i) or (ii) above in a liquid phase polymerisation system in a polymerisation reactor in the presence of an polymerisation catalyst which is capable of giving rise to an atactic structure.

The present invention also provides a process for the preparation of an atactic copolymer having units derived from (a) at least one alpha olefin (b) optionally ethylene and (c) at least one non-conjugated diene selected from the group consisting of

(i) a diene of the Formula:

CH₂═C(R¹)—R²—C(R³)═CH₂ (I)

wherein R¹ and R³ are independently selected from hydrogen or an alkyl group, and R² is an alkylene moiety having a chain length of at least 3 carbon atoms and

(ii) a diene having a cyclic ring with one strained ring double bond and a substituent on the ring of the Formula:

CR⁷═CH₂ (IV)

wherein R⁷ is hydrogen or a C₁-C₃ alkyl group and wherein at least 30 mol % of any units derived from the diene provide pendant groups having a double bond and less than 2 mol % of units derived from the diene provide ‘H’-type branching, said copolymer having a number average molecular weight of less than or equal to 10,000, which process comprises contacting (a) at least one alpha olefin (b) optionally ethylene and (c) at least one non-conjugated diene of Formula (I) or a diene having a cyclic ring with one strained ring double bond and a substituent on the ring of the Formula (IV) in a liquid phase polymerisation system in a polymerisation reactor at a temperature of greater than 40° C. in the presence of a polymerisation catalyst which is capable of giving rise to an atactic structure, with the proviso that when the alpha olefin is propylene, the concentration of propylene is less than or equal to 50% by volume of a diluent.

For preparing an atactic copolymer according to the present invention, suitable catalysts comprise the reaction or complexation product of a cyclopentadienyl-containing transition metal compound (also referred to as a metallocene) and a cocatalyst. Alternatively, transition metal non-metallocene catalysts e.g Ziegler catalysts may be used. Suitable metallocene catalysts include the meso form of bridged metallocene catalysts, Constrained geometry catalysts and monocyclopentadienyl catalysts and unbridged metallocene catalysts. Examples of suitable meso form bridged metallocene catalysts, Constrained geometry and monocyclopentadienyl catalysts may be found in WO 98/49229, the disclosure of which is hereby incorporated by reference. Typically an unbridged metallocene is used, for example (C₅H₅₋ₙRₙ)₂MX₂ where R=alkyl, preferably C1 to C4 alkyl, M═Ti, Zr or Hf, X=alkyl such as C1 to C4; or halide, or a trifluoromethyl sulphonate (hereafter “triflate”) and n has a value from 0 to 5. A suitable catalyst comprises a metallocene of the formula:

[RₘCpH₍₅₋ₘ₎][RₙCpH₍₅₋ₙ₎]M(Z)Y

wherein CpH is a cyclopentadienyl ligand, each R represents an alkyl or an aryl substituent on the CpH ligand or the R substituents on each CpH group when taken to ether represent an Si or C bridging group linking two CpH groups wherein said Si or C group may itself be substituted by hydrogen atoms or C1-C3 alkyl groups, M is a metal selected from hafnium, zirconium and titanium, Z is selected from a hydrogen atom, a halide, a “triflate”, an alkyl or an aryl group, Y is selected from a halide, an alkyl or a 1,3-diketone, a β-ketoester and a triflate, and each of m and n is the same or different and has a value from 0 to 5. The metallocene is converted into an active polymerisation catalyst by reacting or combining it with a co-catalyst.

Preferably, for a copolymer having units derived from (a) at least one alpha-olefin (b) optionally ethylene and (c) at least one non-conjugated diene of Formula (I) or a diene having a cyclic ring with one strained ring double bond and a substituent on the ring of the Formula (IV) and having a number average molecular weight of 500 to 2000, e.g 1000 an unsubstituted metallocene is used. Examples of suitable unsubstituted metallocenes are unsubstituted bis cyclopentadienyl zirconium metallocenes such as bis cyclopentadienyl zirconium dichloride, bis cyclopentadienyl zirconium ditriflate, bis cyclopentadienyl zirconium dimethyl, bis cyclopentadienyl zirconium triflate hexafluoroacetylacetonate

Preferably, for a copolymer having units derived from (a) at least one alpha-olefin (b) optionally ethylene and (c) at least one non-conjugated diene of Formula (I) or a diene having a cyclic ring with one strained ring double bond and a substituent on the ring of the Formula (III)and having a number average molecular weight of 5000 to 10000 e.g 7500 an trisubsituted metallocene is used. Examples of suitable trisubstituted metallocenes are trisubstituted bis cyclopentadienyl zirconium metallocenes e.g bis(1,2,4 trimethyl cyclopentadienyl) zirconium dichloride, bis(1,2,4 trimethyl cyclopentadienyl) zirconium ditriflate, bis(1,2,4 trimethyl cyclopentadienyl) zirconium dimethyl, bis(1,2,4 trimethyl cyclopentadienyl) zirconium triflate hexafluoroacetyl acetonate.

Generally, for a copolymer derived from (a) at least one alpha-olefin (b) optionally ethylene and (c) at least one non-conjugated diene, any metallocene or transition metal non-metallocene catalyst e.g Ziegler catalyst may be used as long as the incorporation of the different monomers in the copolymer chain is random and the non-conjugated diene predominately inserts in the copolymer chain in a non-cyclic fashion. For example, random incorporation of ethylene in the copolymer may be achieved by ensuring that the amount of ethylene in the monomer feed to the polymerisation reaction is less than 50% by weight of the total monomer content of the feed, preferably less than 30% by weight of the total monomer content.

The process of the present invention is carried out in a liquid phase polymerisation system e.g solution, suspension or using a fixed bed. Preferably the process of the present invention is carried out continuously. When the polymerisation is carried out in the solution phase, typically the reactants and catalysts are dissolved in the polymerisation medium. The polymerisation medium may include an inert diluent. Typically, the inert diluent may be a saturated or unsaturated hydrocarbon, for example a saturated or unsaturated aromatic or halogenated hydrocarbon which does not adversely interfere with the polymerisation reaction. Suitable inert diluents include toluene, xylene, isobutane, propane and hexane. Preferably the catalyst is present in the polymerisation medium at a concentration in the range 1 to 100 micromoles/litre, more preferably in the range 5 to 20 micromoles/litre. When the process of the present invention is carried out in suspension or a continuous fixed bed, the catalyst is supported on a support material. Suitable support materials are well known in the art and include silica and alurnina.

The catalyst may be used in conjunction with a cocatalyst. The cocatalyst may be comprised of an alkyl aluminoxane, preferably methyl aluminoxane, with or without the addition of a Group m metal alkyl e.g an alkyl aluminium or an alkyl boron A preferred alkyl aluminium is tri-isobutyl aluminium. A preferred alkyl boron is tri-sec-butyl boron

The aluminoxane is preferably used in an amount such that the molar ratio of metallocene or transition metal non-metallocene catalyst e.g Ziegler catalyst to aluminoxane lies in the range 1:1 to 1:2000, more preferably the ratio lies in the range 1:1 to 1:400 (based on the molar amount of aluminium). When tri-isobutyl aluminium is used the molar ratio of metallocene catalyst to aluminoxane to tri-isobutyl aluminium suitably lies in the range from 1:50:400 to 1:500:500.

The cocatalyst may also be a Lewis acid such as tris (pentafluorophenyl) boron or trityl tetra(pentafluorophenyl) borate when used in combination with the dialkyl derivative of the metallocene. Typically the boron or borate cocatalyst is present in an equimolar amount to the metallocene catalyst.

The cocatalyst may be supported. When a supported catalyst system is used preferably the catalyst and cocatalyst are supported on the same material.

The polymerisation can take place in an inert atmosphere at atmospheric or super atmospheric pressure, preferably at a pressure in the range 10 to 200 bar, more preferably at a pressure in the range 10 to 50 bar.

The polymerisation may take place at a temperature in the range −50 to 300° C., more preferably at a temperature in the range 20 to 120° C.

Variation of the reaction temperature, monomer or catalyst/cocatalyst concentrations or pressure can be used to control both the molecular weight of the polymers, the quantity of alkadiene polymerised and the rate of polymer production. For example, a product of relatively low molecular weight may be achieved by running the reaction at a higher temperature. For example, where it is desired to obtain a copolymer of a number average molecular weight of less than or equal to 10,000 and having units derived from a non-conjugated diene of Formula (I) or a diene having a cyclic ring with one strained ring double bond and a substituent on the ring of the Formula (IV), the polymerisation temperature is preferably greater than 40° C.

The polymerisation reaction can be quenched by methods known in the art, for example by adding water or a lower alcohol such as ethanol or isopropanol.

In the process to prepare a copolymer having units derived from (a) at least one alpha-olefin (b) optionally ethylene and (c) at least one non-conjugated diene of Formula (I) or a diene having a cyclic ring with one strained ring double bond and a substituent on the ring of the Formula (IV), the polymerisation reaction is preferably monitored by solution 13C NMR to detect the existence of‘H’-type branching. Monitoring may be either at regular intervals, or, preferably continuously. The polymerisation reaction should be quenched or killed with a suitable killing agent when the amount of units derived from the diene which provide ‘H’-type branching reaches a value of no more than 2 mol %.

The catalyst residues can be removed by filtration, if necessary, or left in the product or on the catalyst support.

The diluent can be removed from the reaction medium (which comprises the polymer product, diluent, unreacted alkadiene, alpha olefin and optionally ethylene, inactive residues of catalyst and cocatalyst) by evaporation under reduced pressure.

A further aspect of the present invention relates to an oil soluble copolymer having at least one pendant functional group obtainable by chemical modification of at least one pendant group of an atactic copolymer as defined above, said at least one pendant functional group being (a) capable of undergoing further chemical reaction with another material, or (b) imparts desirable properties not otherwise possessed by the atactic copolymer, or both (a) and (b).

A proportion of the double bonds may be unmodified. However, it is preferred that at least 50%, more preferably at least 80%, still more preferably at least 90%, and most preferably substantially all of the pendant groups having double bonds are chemically modified.

Preferably, the “vinylidene end group” of the polymer will also be chemically modified to give a functional group.

Useful and preferred functional groups include halogen, carboxyl moieties present as acids, esters, salts, or anhydrides, alcohols, amines, ketones, aldehydes and the like, as described in U.S. Pat. No. 5,498,809 which is herein incorporated by reference.

Useful functionalisation reactions include: maleinisation, which is the reaction of the copolymer at the point of unsaturation (pendant olefinic group or vinylidene end group) with maleic acid or anhydride; halogenation of the copolymer and subsequent reaction of the halogenated copolymer with an amine or ethylenically unsaturated functional compound; reaction of the copolymer with an unsaturated functional compound by the “ene” reaction in the absence of halogenation; reaction of the copolymer with at least one phenol group (this permits derivitisation in a Mannich base-type condensation); reaction of the copolymer at its point of unsaturation with carbon monoxide using a Koch-type reaction wherein an acid group such as an iso acid or neo acid is formed; reaction of the copolymer with the functional compound by free radical addition using a free radical catalyst; and reaction of the copolymer by air oxidation methods, epoxidation, chloroamination or ozonolysis.

Thus, according to yet a further aspect of the present invention there is provided a copolymer functionalised with reactive groups such as by substitution with at least one mono- or di-carboxylic acid or mono- or di-carboxylic acid derivatives such as acid anhydrides or acid esters produced by reacting the copolymers of present invention with mono-unsaturated carboxylic reactants via thermal or radical initiated reactions, as described in U.S. Pat. No. 5,498,809. The monocarboxylic acid and dicarboxylic acid or anhydride substituted copolymers are useful per se as additives for lubricating oils and, in another aspect of this invention, can also be reacted with nucleophilic reagents such as amines, alcohols, amino alcohols and metal compounds, to form derivative products which are also useful as lubricating oil additives, for example, as dispersants. Suitable nucleophilic reagents and reaction conditions are described in U.S. Pat. No. 5,498,809.

In another aspect of this invention, lubricating oil additives are produced by functionalising the copolymers of the present invention by reaction with an hydroxyaromatic compound in the presence of a catalytically effective amount of at least one acidic alkylation catalyst. Suitable alkylation catalysts include boron trifluoride complexes with alcohols or ethers. The alcohols or ethers may be primary, secondary or tertiary alcohols or ethers. The boron trifluoride/alcohol or ether complexes may be formed in situ or may be preformed. Preferred complexes include boron trifluoride/isopropanol complexes and boron trifluoride diethylether complexes. A preferred hydroxyaromatic compound is phenol. Subsequently, the alkylated hydroxyaromatic compound can be reacted by Mannich Base condensation with an aldehyde and an amine reagent to provide a derivatised polymer.

Lubricatina oil additives may also produced by the oxidation of the copolymer of the present invention, such as oxidation with a gas containing oxygen and/or ozone. The copolymer can also be functionalised by hydroformylation, by epoxidation and by employing the Koch reaction (see U.S. Pat. No. 5,498,809). Such functionalised copolymers can be derivatised by reaction with at least one derivatising compound to form derivatised copolymers.

An advantage of the copolymers of the present invention is that because they contain pendant groups having olefinic moieties in addition to a “vinylidene end group”, the lubricating oil additives (e.g. dispersant additives) produced therefrom have high active ingredient concentrations, thereby providing, for example, enhanced lubricating oil dispersancy and in some cases such additives can be cross-linked.

The invention will now be illustrated by the following examples.

### COPOLYMER PREPARATION (EXAMPLES 1-4)

A 3 litre autoclave was heated to approximately 100° C., and simultaneously thoroughly purged by passing a stream of dry nitrogen through it. The autoclave was then allowed to cool to room temperature (25° C). Into the autoclave was introduced (a) 1 litre of dry toluene via a transfer line, (b) either triisobutyl aluminium (TiBA) (4 ml of a 1M solution in toluene) or 8 ml of 10% solution of MAO (methyl aluminoxane) in toluene and (c) the desired amount of diene which had been freshly distilled from calcium hydride. The autoclave was then sealed and 1 litre of liquid propylene transferred to it. The contents of the autoclave were then stirred at 70° C. The pressure and temperature of the autoclave were logged continuously. The autoclave was flushed with nitrogen and (a) a 12.5 micromoles solution in toluene of bis (1,3 dimethyl cyclo pentadienyl) zirconium dichloride as catalyst and (b) a 3 millimoles solution of methylaluminoxane as co-catalyst were added by syringe into an injection port in communication with the autoclave. After ten minutes, this mixture was injected into the autoclave under a positive pressure of nitrogen and the reaction was allowed to run for the desired period (see Table 1). After venting the reactor, the liquid product was drained into a vessel containing a sufficient amount of isopropanol to kill the catalyst. The resultant product was then washed, initially with a little dilute hydrochloric acid (200 ml) and then with distilled water (200 ml), dried with magnesium sulphate, filtered and the solvent removed by evaporation. Further details of the preparation and the properties of the resulting copolymers are shown in Tables 1 and 2.

### COPOLYMER PREPARATION (EXAMPLE 4a)

A 3 litre autoclave was heated to approximately 100° C., and simultaneously thoroughly purged by passing a stream of dry nitrogen through it. The autoclave was then allowed to cool to room temperature (25° C.). Into the autoclave was introduced (a) 0.5 litres of dry toluene via a transfer line, (b) triisobutyl aluminium (TiBA) (5 ml of a 1M solution in toluene), (c ) 0.28 mol (45 ml) of 1-octene and (d) 0.33 moles (40 g) of ethylidene norbornene. The autoclave was then sealed and 1.5 litres of liquid propylene transferred to it. The contents of the autoclave were then stirred at 50° C. The pressure and temperature of the autoclave were logged continuously. The autoclave was flushed with nitrogen and (a) a 60 micromoles solution in 16 ml of toluene of bis (1,2,4 trimethyl cyclopentadienyl) zirconium dichloride as catalyst and (b) a 20 ml of 10% solution of methylaluminoxane as co-catalvst were added by syringe into an injection port in communication with the autoclave. After ten minutes, this mixture was injected into the autoclave under a positive pressure of nitrogen and the reaction was allowed to run for one hour. 20 ml of ethanol were then injected into the autoclave to kill the reaction. After venting the reactor, the liquid product was drained into a vessel. The liquid product was then stirred with damp silica gel to remove any catalyst residues and subsequently filtered. After filtering, the solvent (toluene) was removed by rotary evaporation to give a viscous liquid product. The viscous liquid product was then heated to approximately 100° C. under high vacuum (0.01 mbar) until all residual monomers had been removed. ¹³C NMR analysis of the copolymer product obtained indicated that the polymer was had 98 mol % propene units, 1 mol % 1-octene units and 1 mol % ethylidene norbornene units.

Further details of the preparation and the properties of the resulting copolymer is given in Tables 1 and 2.

TABLE 1
Reaction of Diene With Propene

| | | | Gram- | | | | |
|---|---|---|---|---|---|---|---|
| | | Gram- | Moles of | | | | |
| | | Moles diene | propene | Reaction | Mole % | Approx. | |
| | | added to the | added to | Time/ | diene in | Reactivity | Copolymer |
| | Diene | reactor | reactor | mins | copolymer | Ratio | Yield/g |
| Experiment A | 1,5-hexadiene | 0.5 | 12.5 | 50 | 2.1 | 0.5* | 300 |
| Experiment B | 4- | 0.5 | 12.5 | 120 | 0 | 0 | 315 |
| | vinylcyclohexene | | | | | | |
| Experiment C | 2-methyl-1,5- | 0.5 | 12.5 | 160 | 4 | 1 | 300 |
| | hexadiene | | | | | | |
| Example | 1,7-octadiene | 0.25 | 12.5 | 160 | 0.9 | 0.6* | 300 |
| 1*** | | | | | | | |
| (R602) | | | | | | | |
| Example | 1,9-decadiene | 0.5 | 12.5 | 70 | 3-4 | ˜1 | 310 |
| 2*** | | | | | | | |
| (R664) | | | | | | | |
| Example | 1,9-decadiene | 0.25 | 12.5 | 140 | 2.4 | ˜1 | 300 |
| 2a** | | | | | | | |
| (R727) | | | | | | | |
| Example | 1,7-octadiene | 0.25 | 12.5 | 120 | 1.0 | 0.6* | 250 |
| 3** | | | | | | | |
| (R603) | | | | | | | |
| Example | 1,7-octadiene | 0.5 | 12.5 | 140 | 1.9 | 0.5* | 340 |
| 4*** | | | | | | | |
| (R604) | | | | | | | |
| Example | ethylidene | 0.33 | 18.75 | 60 | 1.0 | 0.57 | 280 |
| 4a**** | norbornene | | | | | | |

*Approximately unity if both double bonds considered in cyclisation reaction
**Made using TiBA in step (b)
***Made using MAO in step (b)
****0.28 mol 1-octene were also added as a comonomer

In Experiments A, B and C the copolymers produced are not according to the invention. In Examples 1, 2 and 2a, 3, 4 and 4a the copolymers produced are according to the invention. The mole percentage diene in the copolymer was determined using ¹³C NMR and ¹H NMR. The approximate reactivity ratio is the mole ratio of diene to C3 alpha olefin in the copolymer product divided by the mole ratio of diene to C3 alpha olefin in the reactant feed. The closeness of the reactivity ratio to unity suggests that the level of diene incorporation can be controlled by simple variation of the diene level in the feedstock.

TABLE 2

| | Diene in the | | | % incorporated | |
|---|---|---|---|---|---|
| | propylene-diene | | Mol % | diene with free | vinyl as % of |
| | copolymer | | diene in | olefin bond/% | total |
| | (polymer) | Mn | copolymer | diene cyclised | unsaturation |
| Experiment A | 1,5-hexadiene | 3100 | 2.1 | 0/100 | 0 |
| | (R605) | | | | |
| Experiment B | 4- | 3000 | 0 | — | — |
| | vinylcyclohexene | | | | |
| | (R608) | | | | |
| Experiment C | 2-methyl 1,5- | 1300 | 4 | 0/100 | 0 |
| | hexadiene | | | | |
| Example 1 | 1,7-octadiene | 1970* | 0.9 | 40/60 | 13* |
| | (R602) | 1840** | | | 16** |
| | | 1880*** | | | |
| Example 2 | 1,9-decadiene | 4270* | 3-4 | 100/0 | 69.7 |
| | (R664) | | | | |
| Example 2a | 1,9-decadiene | 1700* | 2.4 | 100/0 | 50 |
| | (R727) | 1800** | | | |
| | | 1600**** | | | |
| Example 3 | 1,7-octadiene | 3360* | 1.0 | 43/57 | 24* |
| | (R603) | 3230** | | | 23** |
| | | 3040*** | | | |
| Example 4 | 1,7-octadiene | 1900* | 1.9 | 41/59 | 26* |
| | (R604) | 1792** | | | 24** |
| | | 1980*** | | | |
| Example 4a | ethylidene | 23,000 | 1.0 | 100/0 | 5.3***** |
| | norbornene | | | | |

*¹³C nmr;
**¹H nmr;
***GPC calibrated to Vapour Pressure Osmometry (VPO) for atactic polypropylene.
****By GPC calibrated with atactic polypropylene; Mw/Mn of sample = 3.8
*****ethylidene as % of total unsaturation
— means not measured

The percentage incorporated diene with free olefin bond and the percentage of diene cyclised were measured using ¹³C NMR The percentage unsaturation in the copolymers due to terminal vinyl groups was also measured using ¹³C NMR. The level of unreacted diene in the final product was measured by gas chromatography and found to account for less than 3% of the measured vinyl concentration as shown in Table 2. From Table 2 it can be seen that the copolymers according to the invention, i.e. the copolymers of Examples 1, 2, 2a, 3, 4 and 4a all have pendant groups present whereas the copolymers not according to the invention, i.e. the copolymers of Experiments A, B and C, do not.

Some of the above copolymers were used in functionalisation reactions to illustrate their usefulness as oil additive components

### EXAMPLE 5

20 g of the copolymer of Example 3 (R603) was dissolved in 50 ml of chlorobenzene and added to a solution of 8 g of phenol in 200 ml of chlorobenzene. Then 1 g of BF₃diethylether was added and the resulting mixture was stirred under an inert atmosphere at 40° C. for 6 hours. Ammonia gas was then carefully added until the mixture was neutralised. The mixture was cooled to ambient temperature and filtered and the solvent and excess phenol were removed by evaporation under reduced pressure at approximately 100° C. An alkylated phenol remained as a residue.

### EXAMPLE 6

This example involves the preparation of an amine functionalised copolymer. 10 g of the copolymer of Example 3 (R603) was dissolved in 60 ml of dichloromethane and a solution of 0.01 mol of metachloroperbenzoic acid in 100 ml of dichloromethane was added. Both solutions were at 30° C. The resulting mixture was stirred for two hours then crystallised by cooling. Unreacted metachloroperbenzoic acid was removed together with by-product chlorobenzoic acid by filtration at low temperature. Some solvent was removed by evaporation under reduced pressure and the crystallisation/filtration process repeated. The organic solution, now freed from acids in this way, was evaporated under reduced pressure to remove solvent and a viscous liquid was recovered. The viscous liquid contained epoxide groups and no olefin double bonds, as verified by NMR. This liquid was reacted with 0.2 mol of dimethylaminopropane at 100° C. to give an amine functionalised copolymer.

### EXAMPLES 7 TO 10

These examples involve the preparation of succinic anhydrides of the copolymers and the subsequent preparation of succimides from these succinic anhydrides. Weighed quantities of the copolymer and maleic anhydride were placed in a 600 ml Parr (trade name) autoclave and the autoclave was purged with nitrogen and sealed. The autoclave was then heated quickly to the control temperature and the contents thereof stirred at 500 rpm for the duration of the reaction (see Table 3). The autoclave was then rapidly cooled to 100° C. and depressurised. The resulting succinic anhydride products were then placed in a Buchi Rotavapor and excess maleic anhydride was removed under vacuum at 180° C. The residual copolymers were cooled and then dissolved in heptane and filtered through a Celite (trade name) filter aid. The solvent was then removed by evaporation. The preparative conditions and the properties of these anhydrides are recorded in Table 3. In Example 10, 60 mls of xylene was used as a solvent in the reaction of the copolymers with maleic anhydride.

TABLE 3

| | | | | | Succinic | Succinic |
|---|---|---|---|---|---|---|
| | | | | | anhydride | anhydride |
| | Copolymer | Amount of | Maleic | Time@ | Active | Acid number |
| | of | copolymer/g | Anhydride/g | temperature | Matter | mg KOH/g |
| Example 7 | Example 4 | 50 | 11.2 | 5 hrs @ | 96 | 78.6 |
| | | | | 230° C. | | |
| Example 8 | Example 3 | 50 | 9.8 | 5 hrs @ | 89 | 56.8 |
| | | | | 230° C. | | |
| Example 9 | Example 1 | 50 | 11.7 | 5 hrs @ | 97 | 76.3 |
| | | | | 230° C. | | |
| Example | Example 2 | 50 | 16.3 | 6 hrs @ | 97 | 82.1 |
| 10 | | | | 220° C. | | |

The succinic anhydrides of Examples 7 to 10 in Table 3 were reacted with triethylene tetramine in solvent neutral 150 or SN 150 oil (sold by BP Oil under the trade name Enerpar 11) using one mole of amine for every two moles of anhydride groups in the copolymer chain. The reaction was carried out by reacting a mixture of about 20 wt 5% succinic anhydride with about 80 wt % SN150 oil at 185°°C. for three hours with the amine in a stirred flask with a small nitrogen gas bleed. The resulting solutions from the reactions using the succinic anhydrides of Examples 7 and 8 were diluted using SN 150 oil so as to comprise 90 wt % oil and their viscosity indices were measured. These are shown in Table 4.

TABLE 4

| 10% SN150 solution of succinimide from | Viscosity Index |
|---|---|
| succinic anhydride of Example 7 | 133* |
| (Copolymer of Example 4 (R604)) | |
| succinic anhydride of Example 8 | 154* |
| (Copolymer of Example 3 (R603)) | |
| pure SN150 oil | 72+, 98* |

*U tube viscometer;
+Haake Cone and Plate Viscometer

### EXAMPLE 11

The viscosity index of each of the copolymers of Example 1 (R602), Example 2 (R664), Example 2a (R727), Example 3 (R603) and Example 4 (R604) was determined in the same manner described in EP-A-0 811 642 i.e. according to ISO 2909 by measuring the viscosities at 40° C. and 100° C. of a 10 wt % solution of the copolymers and subsequent conversion according to the tables contained in the ISO standard. The solvent used is a solvent neutral 100 oil, Enerpar 20, manufactured by the British Petroleum Company. The results are shown in Table 5.

TABLE 5

| Copolymer of | Viscosity Index |
|---|---|
| Example 1 (R602) | 121 |
| Example 2 (R664) | 154 |
| Example 2a (R727) | 136 |
| Example 3 (R603) | 135 |
| Example 4 (R604) | 124 |

### EXAMPLE 12

This example involves the preparation of succinic anhydrides of the copolymers and the subsequent preparation of succinimides from these succinic anhydrides.

75 g of the copolymer of Example 2a (R727) was placed in a 300 ml Parr (trade name) autoclave together with 13.13 g of maleic anhydride. The autoclave was sealed and purged with nitrogen. The autoclave was then heated quickly to 230° C. and the contents thereof stirred at 500 rpm for five hours. The autoclave was then rapidly cooled to 100° C., depressurised and opened. The autoclave contents were discharged into a Buchi Rotavapor (trade name). In the Buchi Rotavapor excess maleic anhydride was removed from the autoclave product under vacuum at 200° C. for ninety minutes. The contents of the Buchi were then dissolved in heptane and the solution filtered on a Celite filter bed. The filtrate was collected and stripped of heptane under vacuum at 180° C., leaving a clear light brown viscous liquid (P1). This liquid (P1) was found to have an acid number of 94.6 mgKOH/g and an active matter content (as measured by polar conversion) of 91.3 wt %.

9.97 g of the liquid P1, was added to a three necked flask and diluted with 45 g of solvent neutral 100 oil (Enerpar 20). The oil solution was heated with stirring to 180° C. and 0.623 mls of triethylene tetramine was added over circa fifteen minutes to the flask contents from a syringe. The contents were stirred at 180° C. whilst being further diluted to 10 wt % with more SN 100 oil. This 10 wt % solution stirred at 180° C. for a total of three hours whilst a small bleed of nitrogen gas was passed through the solution. The contents of the flask were then finally cooled, the viscosity was measured at 40 and 100 ° C. and the viscosity index of the solution was calculated to be 172.

1-17. (cancelled).

18. A process for the preparation of an atactic copolymer having units derived from (a) at least one alpha olefin (b) optionally ethylene and (c) at least one non-conjugated diene selected from the group consisting of a diene of the Formula:
(i) CH₂═C(R¹)—R²—C(R³)═CH₂ (I)
wherein R¹ and R³ are independently selected from hydrogen or an alkyl group, and R² is an alkylene moiety having a chain length of at least 3 carbon atoms and
(ii) a diene having a cyclic ring with one strained ring double bond and a substituent on the ring of the Formula:
—CR⁷═CH₂ (IV)
wherein R⁷ is hydrogen or a C₁-C₃ alkyl group
and wherein at least 30 mol % of any units derived from the diene provide pendant groups having a double bond and less than 2 mol % of units derived from the diene provide ‘H’-type branching, said copolymer having a number average molecular weight of less than or equal to 10,000, which process comprises contacting (a) at least one alpha olefin (b) optionally ethylene and (c) at least one non-conjugated diene of Formula (I) or a diene having a cyclic ring with one strained ring double bond and a substituent on the ring of the Formula (IV) in a liquid phase polymerisation system in a polymerisation reactor at a temperature of greater than 40° C. in the presence of a polymerisation catalyst which is capable of giving rise to an atactic structure, with the proviso that when the alpha olefin is propylene, the concentration of propylene is less than or equal to 50% by volume of a diluent.

19. 11. A process according to claim 18 wherein the diene is selected from the group consisting of 1,7 octadiene, 1,8 nonadiene, 1,9 decadiene, 1,10 undecadiene, 1,11 dodecadiene, vinyl norbornene and 5-(1-methylethenyl)norbornene.
